(19) United States
(12) Patent Application Publication
(10) Pub. No.: US 2013/0321258 A1
(43) Pub. Date: Dec. 5, 2013

(54) TWO-WAY COMMUNICATION SYSTEM BY USING EYE MOVEMENTS

(71) Applicants: CHIA-CHUN TSOU, New Taipei City (TW); CHIH-HENG FANG, New Taipei City (TW); PO-TSUNG LIN, New Taipei City (TW); YUNG-JAY LIANG, New Taipei City (TW)

(72) Inventors: CHIA-CHUN TSOU, New Taipei City (TW); CHIH-HENG FANG, New Taipei City (TW); PO-TSUNG LIN, New Taipei City (TW); YUNG-JAY LIANG, New Taipei City (TW)

(21) Appl. No.: 13/617,213

(22) Filed: Sep. 14, 2012

(30) Foreign Application Priority Data
Jun. 5, 2012 (TW) 101120165

(51) Int. Cl. G09G 5/00

(52) U.S. Cl. 345/156

(57) ABSTRACT

A two-way communication system by using eye movements of the present invention comprises a first display module, a second display module and a data processing module. The first display module is configured to display first operative window interface and to detect the eye movements of the users to provide various operation and control. The second display module is configured to display user information, which allows the users to communicate with others immediately and conveniently. The data processing module is electrically connected with the first display module and the second display module, which responses each operation command and transmits the information. The first and second display modules can be adjusted freely for users' convenient review and operation.

### BACKGROUND OF INVENTION

1. Field of Invention

The invention relates to an auxiliary communication system, and more especially to a two-way communication system by using eye movements to allow users to communicate with others.

2. Related Prior Art

A great deal of technology that detects eye movements for control purpose has been developed and well known in public. For instance, U.S. Pat. No. 6,003,991 (hereinafter called '991) suitable for medical field is entitled as “Eye examination apparatus and method for remote examination of a patient by a health professional”, which relates to glasses for a patient to wear. A camera is disposed in front of the glasses for capturing images of patient's eyes. The images of the patient's eyes are then sent to a computer device and a display by transmission lines. As such, a doctor can clearly examine patient's eyes, thereby performing treatment or medical research. Numerous research teams, such as TempOne, Graffiti Research Lab, OpenFrameworks, The Ebeling Group and etc., developed an eye control device, named as “The EyeWriter”, in 2007. The EyeWriter is a project developed by a group of software program developing experts who aim to help a street performer, Samuel Taylor Coleridge suffering from ALS (Amyotrophic lateral sclerosis) that makes him progressive immobility, allowing him to create art using only his eyes. The EyeWriter is to detect eye movements by using two cameras attached to the frames of the glasses and facing user's eyes, and by using software to read data, which allows Samuel to paint again only using his eyes instead of his hands.

In addition, MyTobii P10 is an auxiliary device for helping patients, which has developed by Tobii Company, a Sweden company. The basic principle of this device is to detect eye movements to perform control function, which is similar to the previously mentioned device. The difference between The EyeWriter and MyTobii is that MyTobii includes a LCD screen and an eye movement detector located below the LCD screen. The eye movement detector of MyTobii detects the eye movements of a patient, thereby controlling a mouse cursor on the LCD screen simultaneously. Thus, patients can operate functions on the LCD screen by using their eyes. Besides, products, such as Tobii C15, Tobii C8, Tobii C12 and etc. also have similar functions.

As disclosed by the above-mentioned technology, such as '991, The EyeWriter, and MyTobii, they are similar solutions based on different motivation, which could be operated reasonably and has certain effects. However, the device disclosed by '991 and The EyeWriter is not very convenient for those patients who have already worn a pair of glasses or who are lying on a bed because this kind of device includes a camera attached to glasses and located in front of the glasses or below the glasses for capturing images of eyes. In one aspect, in order to well support the cameras that are additionally attached onto the frames of the glasses, it is necessary to redesign the frames of the glasses to meet the needs. This would thus limit the shape of the glasses, which gives users less choices for glasses. In another aspect, patients who are not able to move freely and have to lie on the bed due to surgery or other reasons, need nurses' help to turn over. When patients is turned aside to perform any kinds of medical treatment, like changing medicine, the frames of the glasses would be moved away from the original position where captures the images of eyes. Moreover, when the patient is turned to the left side or the right side, the frame of glasses would press patients' ears. Accordingly, the aforementioned situations would cause various troubles in practical use.

### SUMMARY OF INVENTION

The products made by Tobii Company still exist few problems which need to be solved although there is no problem when using the glasses. There is a common situation. When the patient feels uncomfortable and wants to inform the medical care personnel, the medical care personnel have to watch the screen at the patient's side to know what the patient wants, and therefore provide medical treatment. However, in practical use, the screen faces the patient, and thus there are only two ways to know what information the patient sent. First, the medical care personnel have to move near the patient and view the screen at the same viewing angle as the patient does. Second, the medical care personnel can adjust the patient's screen. Nevertheless, in fact, it causes some problems no matter which way are used. The present invention discloses a two-way communication system by using eye movements, which allows the patient to quickly and conveniently communicate with the medical care personnel or their family or their friends without any problems.

The system of the present invention has advantages of quickly and clearly informing the medical care personnel of the patient's situation.

The system of the present invention can help the patients who cannot move or speak. The medical care personnel can immediately assist the patients, such as Amyotrophic lateral sclerosis (ALS)/Motor neuron disease (MND), Muscular dystrophy (MD), Cerebral palsy (CP), Multiple Sclerosis (MS), Spinal Cord injury (SCI), Cerebral vascular accident (CVA), Spinocerebellar Atrophy (SCA), Parkinson's disease (PD) and etc., by using the system of the present invention.

The system of the present invention comprises several movable cantilever arms, which allows user to quickly adjust the operation position and which is very convenient for storage.

The system of the present invention is designed to be moved freely and easily without great efforts. In particular, it is often to clean the hospital environment, or to perform various therapies, such as giving intravenous infusion, giving an injection, taking medicine, applying plaster and etc., and therefore the system of the present invention meets the needs of movability and convenience.

The two-way communication system by using eye movement of the present invention comprises a first display module, a second display module and a data processing module. The first display module is configured to display a first operative window interface. The first display module further has a detection and control unit for detecting the eye movements of the user to generate a control command base on the detected eye movements. The second display module is configured to display user information. The data processing module is electrically connected with the first display module and the second display module. The data processing module is configured to provide the first operative window interface displayed on the first display module. The data processing module is based on the control commend to allow users to control the first operative window interface so that the data processing module generates an execute command. The data processing module is configured to provide the user information displayed on the second display module according to the execute command.

Preferably, the system of the present invention further comprises a support main post. The data processing module is located in an end of the support main post, and the first and the second display modules are located in another end of the support main post.

Preferably, the system of the present invention further comprises a movable frame. The movable frame has a first end connected with the first display module and a second end connected with the support main post. This allows the first display module to move to a suitable operation position when being forced.

Preferably, the system of the present invention further comprises a handle portion located on a side of the support main post and a roller set located on a bottom side of the support main post. Thus, the two-way communication system can be moved easily by applying a force on the handle portion to cause the roller set to rotate.

Preferably, the second display module further comprises a touch panel for users or the medical care personnel to operate.

Other features, objects, aspects and advantages will be identified and described in detail below.

### BRIEF DESCRIPTION OF DRAWINGS

FIG. 1 is a perspective view of the system of the present invention;

FIG. 2 is an enlarged perspective view of the system of the present invention;

FIG. 3 is a first enlarged perspective view of the system of the present invention; and

FIG. 4 is a second enlarged perspective view of the system of the present invention.

### DETAILED DESCRIPTION OF EMBODIMENTS

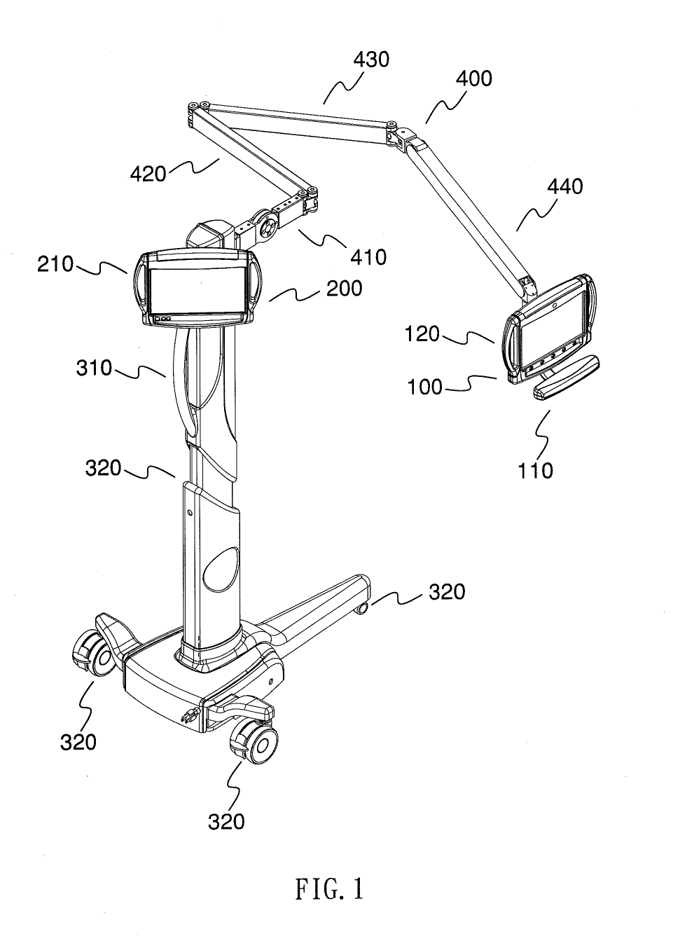

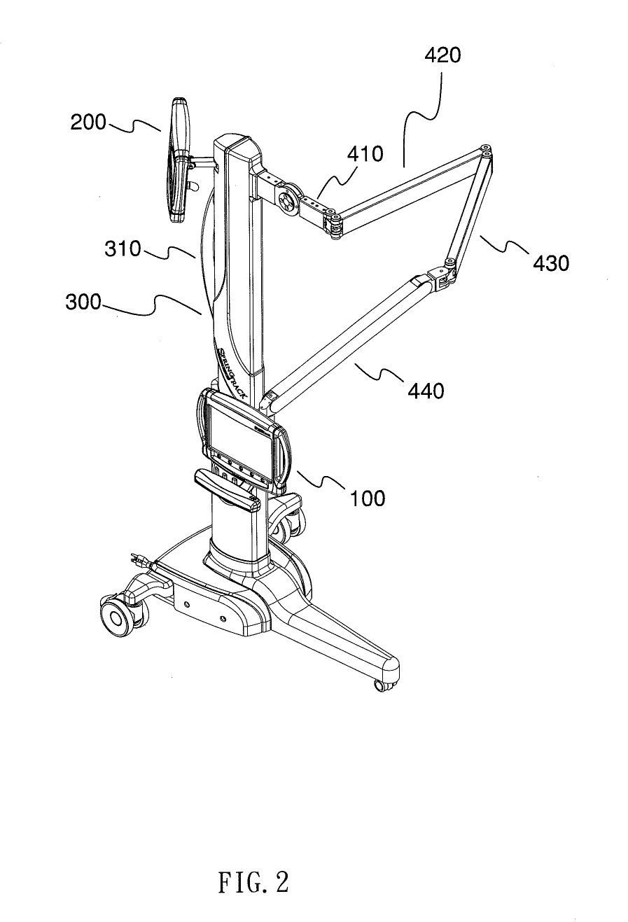

With reference to the FIGS. 1 and 2, a two-way communication system by using eye movements is shown in accordance with an embodiment of the present invention. The system mainly comprises a first display module 100, a second display module 200 and a data processing module. The first display module 100 is configured to be operated by a first user (such as a patient). The second display module 200 is configured to be operated by a second user (such medical care personnel). The first display module 100 is configured to display a first operative window interface. The first display module 100 includes a detection and control unit 110 located at a lower end of the first display module 100. The detection and control unit 110 is configured to detect the eye movements of the first user (the patient) to generate a control command base on the detected eye movements. The second display module 200 is configured to display user information. Preferably, the second display module 200 further comprises a touch panel disposed thereon for the medical care personnel's convenience to operate. A support main post 300 comprises the data processing module (not shown in the drawings) located in one end the support main post 300, or called as a bottom end of the support main post 300. A plurality of data signal transmission lines or power cords and etc. (not shown in the drawings) are embedded in a main body of the support main post 300, which allows the data processing module to be electrically connected with the first display module 100 and the second display module 200 for transmitting data and signal. The data processing module is configured to generate the aforementioned first operative window interface displayed on the first display module 100, which enables the user (the patient) to operate the first operative window interface by using their eyes. More specifically, the user moves their eyes to operate the first operative window interface by using the detection and control unit 110 to detect the eye movements of the user. The data processing module receives the control command generated from the detection and control unit 110 so that the user can control the first operative window interface of the first display module 100 to generate a control result.

The data processing module generates an execute command according to the control result. After that, the data processing module is configured to provide the user information displayed on the second display module 200 according to execute command.

For example, when the patient gets back pain, the patient can operate the first operative window interface of the first display module 100 to generate a user information, such as “back pain”, by detecting the eye movements and generating a control command from the detection and control unit 110. Preferably, the first operative window interface is capable of proving several of predetermined operative interfaces including each part of the body, such as head, chest, back, left/right hand, left/right foot and etc., and common sensation, such as pain, itch, sting, numbness, sore and etc., for patients to enter the desired information quickly. In addition, the user can quickly enter various messages, such as “I want to drink water.”, “Please turn off the light.', “Thank you for your flowers.” and etc. More specifically, the first operative window interface is capable of providing several of predetermined operative interfaces (i.e. icons), including each part of the body (such as head, chest, back and etc.) and common sensation (such as pain, itch, sting and etc.), such that the patient can respectively select one part of the body (like “back”) and one of the common sensation (like “pain”) from the first operative window interface to express how he/she feels (such as “back pain”); alternatively, the first operative window interface can be also capable of providing several of interfaces (i.e. icons) representing different kinds of vocabulary, such as I, you, want, thank, please, water, flower, pain and etc., which allows the patient to select the desired words to express what he/she wants or how he/she feel (such as “I want to drink water.”). This kind of messages or the user information mentioned above is thus displayed on the second display module 200, such that the medical care personnel would quickly understand what their patients want and then help them immediately. In conventional technology, the only way that the medical care personnel would understand what their patient want to express from reading on the display screen is to move the patient's screen, or to view the screen at the same viewing angle as the patient dose. The present invention provides a two-way communication system by using eye movements, which allows the patient to communicate with others more instantly and conveniently without any problems. Except the above-mentioned functions of displaying the user information on the second display module 200, the two-way communication system of the present invention further provides the function that allows user to operate various software programs, such as playing audio, browsing websites, writing emails and etc., by using the eye movements. The second display module 200 is further configured to include a touch panel, which enables the second display module 200 to display a second operative window interface thereon for the medical care personnel to set and operate the system.

The following illustration shows the other components of the two-way communication system of the present invention. The first display module 100 has first hand grip portions 120 located on the two ends thereof, which allow the user to conveniently adjust the operation position of the first display module 100 to place the first display module 100 in front of the patient for exactly capturing the images of patient's eyes by detection and control unit 110. In the same way, the second display module 200 has second hand grip portions 210 located on the two ends thereof, which allows the medical care personnel to conveniently adjust the angle and the position of the second display module 200 for their convenient monitor. The support main post 300 has a handle portion 310 located on one side the support main post 300, and a roller set 320 attached on the bottom side of the support main post 300. As such, the medical care personnel can change the location of the system of the present invention by applying a force on the handle portion 310 that causes the roller set 320 to rotate. Due to the higher standards of keeping hospital clean, or various therapies, such as giving intravenous infusion, giving an injection, taking medicine, applying plaster and etc., it is often to move these kinds of devices. Accordingly, the design of the handle portion 310 and the roller set 320 of the system of the present invention can meet the needs of movability and convenience.

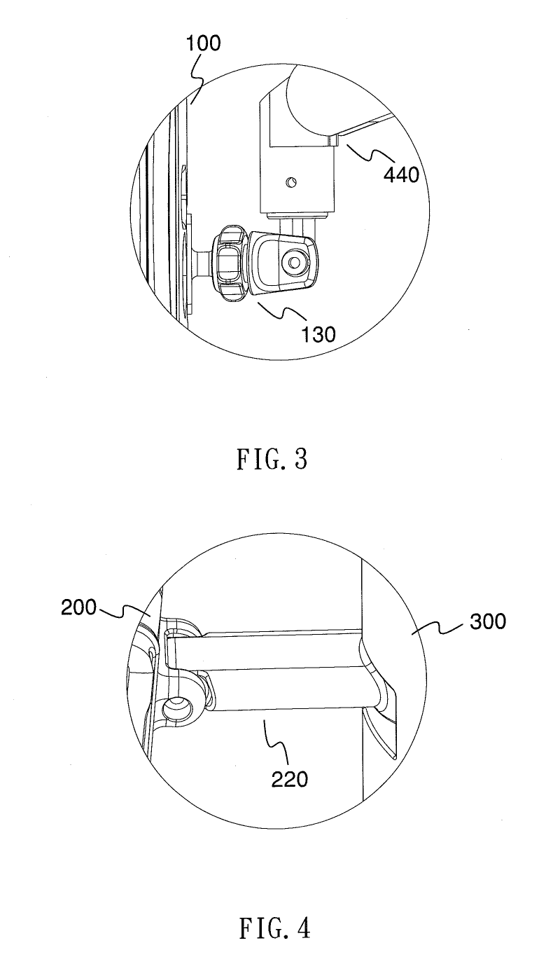

The movable frame 400 has two ends respectively connected with the first display module 100 and the support main post 300. The movable frame 400 mainly comprises a first cantilever arm 410, a second cantilever arm 420, a third cantilever arm 430 and a fourth cantilever arm 440. These cantilever arms are connected with each other, and the two connecting cantilever arms is capable of being rotated correspondingly. When applying a force on the first hand grip portion 120 of the first display module 100 to move the aforementioned cantilever arms, the position of the first display module 100 can be therefore adjusted. As shown in FIG. 3, the first universal connector structure 130 is respectively connected with the fourth cantilever arm 440 of the movable frame 400 and the first display module 100, such that the first display module 100 can be rotated a predetermined angle relative to the movable frame 400 to adjust the angle of the first display module 100 to have a good visual range for the patient. As shown in FIG. 4, the fifth cantilever arm 220 is respectively connected with the support main post 300 and the second display module 200, such that the position of the second display module 200 can be adjusted relative to the support main post 300 by the medical care personnel, thereby having a good visual range.

It will be appreciated that although a particular embodiment of the invention has been shown and described, modifications may be made. It is intended in the claims to cover such modifications which come within the spirit and scope of the invention.

The invention claimed is:

1. A two-way communication system by using eye movements, the system comprising:
a first display module for displaying a first operative window interface, the first display module comprising a detection and control unit for detecting the eye movements and generating a control command based on the detected eye movements;
a second display module for displaying a user information; and
a data processing module, electrically connected with the first display module and the second display module, the data processing module configured to provide the first operative window interface displayed on the first display module, the data processing module being based on the control commend to allow users to control the first operative window interface so that the data processing module generates an execute command, the data processing module configured to provide the user information displayed on the second display module according to the execute command.

2. The two-way communication system by using eye movements of claim 1, further comprising a support main post, the data processing module located in an end of the support main post, the first and the second display modules located in another end of the support main post.

3. The two-way communication system by using eye movements of claim 2, further comprising a movable frame, the movable frame having a first end connected with the first display module and a second end connected with the support main post, which allows the first display module to move to an operation position when being forced.

4. The two-way communication system by using eye movements of claim 3, wherein the movable frame comprises a first cantilever arm, a second cantilever arm, a third cantilever arm and a fourth cantilever arm for adjusting a position of the first display module.

5. The two-way communication system by using eye movements of claim 3, further comprising a first universal connector structure, the first universal connector structure respectively connected with the movable frame and the first display module for allowing the first display module to be rotated a predetermined angle relative to the movable frame.

6. The two-way communication system by using eye movements of claim 2, further comprising a fifth cantilever arm, the fifth cantilever arm connected with the support main post and the second display module for adjusting a position of the second display module relative to the support main post.

7. The two-way communication system by using eye movements of claim 2, further a handle portion located on a side of the support main post and a roller set located on a bottom side of the support main post.

8. The two-way communication system by using eye movements of claim 3, further comprising a first hand grip portion located on the first display module.

9. The two-way communication system by using eye movements of claim 6, further comprising a second hand grip portion located on the second display module for adjusting a position of the second display.

10. The two-way communication system by using eye movements of claim 1, wherein the second display module further comprises a touch panel for users to operate.

11. A two-way communication system by using eye movements, the system comprising:
a first display module for displaying a first operative window interface;
a second display module for displaying a user information; and
a data processing module, electrically connected with the first display module and the second display module, wherein the data processing module is configured to provide the first operative window interface and the user information that is based on a control result generated by controlling the first operative window interface.

12. The two-way communication system by using eye movements of claim 11, wherein the first display module comprises a detection and control unit for detecting eye movements, which allows a user to control the first operative window interface by using eye movements.

13. The two-way communication system by using eye movements of claim 12, further comprising a support main post, wherein the first display module and the second display module are located on the support main post.

14. The two-way communication system by using eye movements of claim 13, further comprising a movable frame, the movable frame having a first end connected with the first display module and a second end connected with the support main post for allowing the first display module to move to an operation position when being forced, wherein the movable frame comprises a plurality of cantilever arms connected with each other in end-to-end relation, and the two connected cantilever arms are capable of relatively rotating.
